(19) United States
(12) Patent Application Publication
(10) Pub. No.: US 2005/0078816 A1
(43) Pub. Date: Apr. 14, 2005

(54) Robot-phone

(76) Inventors: Dairoku Sekiguchi, Tokyo (JP); Masahiko Inami, Tokyo (JP); Naoki Kawakami, Tottori-shi (JP); Ichiro Kawabuchi, Tokyo (JP); Susumu Tachi, Tsukuba-shi (JP)

Correspondence Address: Oliff & Berridge, PO Box 19928, Alexandria, VA, 22320, US

(21) Appl. No.: 10/504,030

(22) PCT Filed: Sep. 12, 2002
(86) PCT No.: PCT/JP02/09336

(30) Foreign Application Priority Data
Feb. 13, 2002 (JP) 2002-34848

(51) Int. Cl. H04M 1/00

(52) U.S. Cl. 379/419

(57) ABSTRACT

A robot-phone enabling human communication by synchronizing shapes, motions, and positions of a plurality of robots located at a distance from one another. The robot-phone is used as a user interface and includes a robot of a stuffed doll having a movable potion at a part of the body, a microphone (11) for communication, a speaker (12), a driving portion (13) for driving the movable portion, a position information sensor (14) for acquiring position information of the movable portion, and a communication connecting portion (16). The communication connecting portion transmits a speech signal from the microphone to a communication partner via a communication line, reproduces the speech signal received from the communication partner in the speaker, transmits a signal indicating the position of the movable position from the position information sensor to the communication partner, receives position information corresponding to the movable portion from the communication partner, and transmits this to the driving portion. The driving portion drives the movable portion according to the received position information. Communication can also be performed by gesture of the robot in addition to speech.

### TECHNICAL FIELD

The present invention relates to a robot-phone as one of robotic user interfaces (RUIs) enabling an interpersonal communication by synchronizing shapes, motions, and positions of a plurality of robots separated by a distance from one another.

### BACKGROUND ART

Recently, robots which work for or coexist with man, such as robot pet, humanoid, museum tour-guide robot and nursing care robot, have become popular. Each of these robots is far more impressive than a CG character moving around in a screen of a computer monitor, and this is considered as a factor of the popularity of the robots.

Each of such robots can be considered as a computer embodied with a physical body. The impressiveness of the robot derives from the existence of the physical body, and through a physical interaction using its body, the robot can exercise a great influence on the real world.

There is proposed a concept referred to as robotic user interface, where the robot capable of powerfully interacting with the real world is recognized as an interface between the real world and the information world (Y. Wakita, S. Hirai, K. Machida, K. Ogimoto, T. Itoko, P. Backes and S. Peters; “Application of intelligent monitoring for super long distance teleoperation”; Proc., IEEE IROS '96, Osaka, pp. 1031-1037, 1996). By utilizing the robot particularly as a user interface, i.e. a robotic user interface (RUI), there can be established a user interface environment which is oriented to the real world and allows input and output from and to the real world. In addition, by taking advantage of the characteristics of the robot as a general purpose machine, it is made easy to assure a versatility to some extent even when using a physical interface.

The “teleexistence” and “object-oriented teleexistence” are implementations of the RUI to connect a real world and another real world. The term “object-oriented teleexistence” refers to a concept to share the shape and motion of an object located at a remote place to thereby enable to perform a work in the remote place or communicate with a communication partner in the remote place.

In the conventional teleexistence/telepresence implementation, the immediate environment of the remote robot is taken in and reconstructed around an operator to communicate realistic sensations to the operator, who can thereby control the remote robot as if he/she is present by the robot. Since the teleexistence is a technology involving, as a prerequisite, highly realistic sensations provided to the operator, the load on the hardware and software related to the measurement, communication and presentation of the realistic sensations tends to be heavy. Further, since the teleexistence technology is such that the operator controls the remote robot with the sensation that he/she is the remote robot itself, that is, from the first-person point of view, it is most effective when the slave robot has a construction, size and motion characteristics which are similar to those of man. However, by the state of the art, even it is difficult to produce a robot similar to man in construction, and there remain considerably many technical problems to be solved for achieving the equal or higher motion characteristics compared with man in a humanoid robot. Further, it is considered that depending upon the target to be operated and the field of the application, e.g., a mobile robot or construction equipment, there are many cases where it is advantageous in terms of operationality that a slave robot is not of the construction and size of man, and/or that the point of view is not of the first person, but of the third person (overhead point of view).

Therefore, the invention of the present application proposes controlling a remote robot more simply and intuitively, by reconstructing the remote robot itself in front of a user, and not by reconstructing the remote environment by the user. In contrast to the conventional teleexistence technology which offers an environment-oriented system, principally seeking to connect the remote environment and the operator as closely and transparently as possible, the present invention offers an object-oriented teleexistence technology, principally seeking to connect the remote robot and the device in front of the operator as closely as possible.

As documents disclosing a communication with the remote location through sharing the haptic sensation, the followings are known:
(1) Brave, S., and Dahley, A.; in Touch: A Medium for Haptic Interpersonal Communication, Extended Abstracts of CHI '97, pp. 363-364, ACH Press, 1997.
(2) Brave, S., Ishii, H., and Dahley, A.; Tangible Interface for Remote Collaboration and Communication, Proceedings of CsCW '98, pp. 169-178, ACM Press, 1998.
(3) Fogg, B. J., Cutler, L., Arnold, P., and Eisback C.; HandJive: a device for interpersonal haptic entertainment, Proceedings of CHI '98, pp. 57-64, ACK Press, 1998.

Document (1) relates to communication of only the rotational motion of three wooden rollers. Document (2) relates to an object like a chess piece, while document (3) relates to the inflation of a balloon gripped in the user's hand. Thus, any of these documents tried to transfer not foreground information like gesture of human body but ambient information like rotation or movement of an object. On the other hand, the present invention enables to share haptic information of a relatively wide range as well as to communicate visual information, i.e., gestural information.

As documents disclosing a technique where a stuffed animal or doll is employed as a user interface, the following are known:
(4) Yukiko Hoshino, Yasutada Suzuki, Hideko Yamamoto, Noritaka Hirokawa, Masayuki Inaba, and Hirochika Inoue; Development of desktop whole-body humanoid robot for research of audio/visual/tactile interaction in daily life, the Robotics Society of Japan, Academic lecture (16th), pp. 5-6, 1998.
(5) Tomoko Yonezawa, Brian Clarkson, Michiaki Yasumura, Kenji Mase; Context-aware Sensor-Doll as a Music Expression Device, IPSJ Interaction2001 Symposium, pp.19-20, 2001.

Hoshino et al. utilize a stuffed doll as a physical agent, while Yonezawa et al. utilize a doll as an input interface for an interactive manipulation of music.

Thus, both documents (4) and (5) do not utilize a doll for a communication of the object-sharing type.

### DISCLOSURE OF THE INVENTION

An object of the present invention is to provide a robot-phone enabling an interpersonal communication by synchronizing shapes, motions, positions, etc., of a plurality of robots placed at respective locations separated by a distance from one another.

In particular, this invention aims to provide a robot-phone which does not suffer from a trouble in the case of a temporary disruption of a communication line or an abrupt disconnection of the communication line, caused by some reason.

The invention also aims to provide a robot-phone controllable depending on a communication band, where a frequency band of a communication line (i.e., communication speed) is varied.

The invention also aims to provide a robot-phone capable of preventing an oscillation of a control system due to a communication delay.

The invention provides a robot-phone comprising: a robot which is used as a user interface and comprises a movable portion at a part of a body of the robot-phone, a driving portion which drives the movable portion, a position information sensor which outputs a signal indicative of a position of the movable portion, and a shut-off portion which stops an operation of the driving portion; and a communication connecting portion. The communication connecting portion transmits the signal indicative of the position of the movable portion outputted from the position information sensor, to a partner of a communication via a communication line, and receives position information corresponding to the movable portion from the partner and sends the position information to the driving portion, which drives the movable portion based on the position information. The communication connecting portion monitors the status of the communication line, and stops a movement of the driving portion by operating the shut-off portion where an abnormality of the communication line is found.

The invention provides a robot-phone comprising: a robot which is used as a user interface and comprises a movable portion at a part of a body of the robot-phone, the robot further comprising: a driving portion which drives the movable portion, a position information sensor which outputs a signal indicative of a position of the movable portion, and an impedance varying means which varies an impedance of the movable portion; and a communication connecting portion. The communication connecting portion transmits the signal indicative of the position of the movable portion outputted from the position information sensor, to a partner of a communication via a communication line, and receives position information corresponding to the movable portion from the partner and sends the position information to the driving portion, which drives the movable portion based on the position information. The communication connecting portion monitors the status of the communication line, and sends a signal indicative of the status to the impedance varying means to thereby vary the impedance of the movable portion accordingly.

The invention provides a robot-phone comprising: a robot which is used as a user interface and comprises a movable portion at a part of a body of the robot-phone, a driving portion which drives the movable portion, and a position information sensor which outputs a signal indicative of a position of the movable portion; and a communication connecting portion comprising a filter which limits a frequency of an input signal to the robot and/or of an output signal from the robot. The communication connecting portion transmits the signal indicative of the position of the movable portion outputted from the position information sensor, to a partner of a communication via a communication line, and receives position information of the movable portion from the partner and sends the position information to the driving portion, which drives the movable portion based on the position information. The communication connecting portion monitors the status of the communication line, and adjusts characteristics of the filter depending upon the status.

### BRIEF DESCRIPTION OF THE DRAWINGS

FIG. 1 is a view showing an example of a robot-phone according to one embodiment of the invention.

FIG. 2 is an illustrative view showing how the robot-phone is used.

FIG. 3 is a view showing another example of the robot-phone according to the embodiment.

FIG. 4 is an illustrative diagram of a control system of the robot-phone.

FIG. 5 is a functional block diagram of a control system according to a first embodiment of the invention.

FIG. 6 is a functional block diagram of a robot according to the first embodiment.

FIG. 7 is a flowchart illustrating an operation of the control system.

FIG. 8 is a view showing another control system according to the first embodiment.

FIG. 9 is a functional block diagram of a control system according to a second embodiment of the invention.

FIG. 10 is a functional block diagram of a robot according to the second embodiment.

FIG. 11 is a view showing another robot according to the second embodiment.

FIG. 12 is a functional block diagram of a control system according to a third embodiment of the invention.

FIG. 13 is a view showing another control system according to the third embodiment.

### BEST MODE FOR CARRYING OUT THE INVENTION

First Embodiment of the Invention

The present invention relates to a shape sharing system as one form of an object-oriented teleexistence technology. The term “shape sharing system” refers to a system where the shapes of objects placed at respective locations separated by a distance are made coincident, so that a shape of an object is shared, enabling an interaction with a partner at a remote place. Shape is one of the most fundamental elements involved in identifying or recognizing an object, and is of importance in obtaining the state of the object. The shape sharing system achieves a close connection between a remote robot and a device at hand, by performing a synchronization of shape which plays an important roll in recognizing an object.

A real-time shape synchronization enables not only a communication of a static shape of an object, but also of a motion which represents the course of a shift in shape. In addition, since the shape of the object at hand presents the very shape of the other object at the remote place, the objects serve as a display. The input and output are performed by a single device, realizing an intuitive operation system which omits switching between input and output. Further, since the interaction with the object is performed through a bodily organ which is capable of both receiving a sensory input from, and giving an output to, the external world, namely, hands, the present system falls within the category of the interactive interface, in its nature.

In the invention, a robot capable of powerfully interacting with the real world is used as an interface between the real world and information world, i.e., Robotics User interface (RUI).

RUX is characterized by the following:
Enables robot to interact with the physical world, that is, to perform works such as actually moving an object.
Enables visual presentation of information through the shape and notion of robot.
Enables haptic presentation of information by application of a force from robot to man.
Man directly touches a robot to change its shape to input instructions into the robot.
Enables speech interaction between man and robot, namely, man speaks to robot and robot also speaks in RUI.

As one form of RUI, a robot-phone has been proposed. The robot-phone is a RUI for an interpersonal communication established by synchronizing shapes, motions, positions, etc. of a plurality of robots placed at respective locations separated by a distance from one another. The robot-phone performs the synchronization of the shape on the real-time basis, so as to enable a communication of not only information indicative of the shape of the object but also information indicative of the motion of the object. Further, unlike the ordinary avatars displayed on computer monitor, the robot-phone is capable of interacting with real world. In other words, robot-phone is capable of displaying and sensing force information by actually touching the user, and is capable of performing some task in remote environment like moving a real object. That is, the robot-phone is a phone capable of representing information in a manner integrated with regard to the visual, tactual and aural aspects. It is noted that when users of both sides of a communication simultaneously apply a force to the robot, the users sense the force of each other.

In general, robots are categorized in two types, namely, autonomous robot which makes determination based on information such as that obtained by sensor and operates automatically, and heteronomous robot where determination is made by man. The robot-phone is categorized in the latter type.

There will be described en example of the robot-phone.

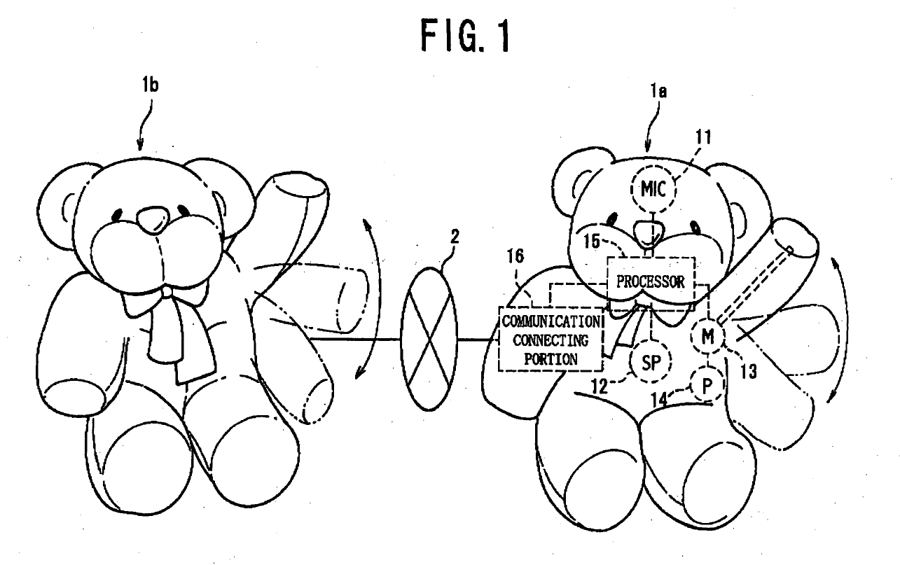

FIG. 1 shows a robot-phone of stuffed-doll type. That is, reference numerals 1a, 1b in FIG. 1 denote a robot-phone incorporated in a teddy bear, which has a microphone 11, a speaker 12, a motor/planetary gear reducer 13, a position detecting means (potentiometer) 14, a processor 15 for controlling these components 11-14, and a communication connecting portion 16. The speaker 12 is mounted in the chest of the teddy bear, while the microphone 11 is mounted in the head of the teddy bear. The speaker 12 and the microphone 11 are embedded, facing the front, in the teddy bear together with a frame. The user faces the robot-phone when making a speech communication and manipulating the robot-phone. Thus, the user can get the sense that the user is having a conversation with another user on the other side of a communication line.

Although it is not shown in FIG. 1, a motor/planetary gear reducer 13 and a position detecting means 14 are provided at each location corresponding to each of the joints of the frame, for instance, in the right arm or head of the doll. The motor/planetary gear reducer 13 and position detecting means 14 constitute an actuator of four degree-of-freedom in total, namely, two degree-of-freedom at the right arm plus two degree-of-freedom at the head. To achieve the degree of freedom closer to that of man and to reduce the force required when moving movable parts of the doll, it is preferable that each of four limbs of the doll has two degree-of-freedom and the head has three degree-of-freedom, totaling in eleven degree-of-freedom as the whole body. This design enables to output a signal representative of a shift in position of the doll caused by application of an external force, and to shift the position of the doll based on a signal from the external. The processor 15 performs a bilateral control such that the robot-phones 1a, 1b are held synchronized in position. The term bilateral means bidirectional. As an example of a bilateral control, there is known a control method according to which a weight or reaction force (contact sensation) received by a manipulator is transmitted to a control lever or others in the form of a weight. The two robot-phones 1a, 1b are connected to a communication network 2 through which a speech communication between the users of the robot-phones 1a, 1b is made, as well as each user can reflect a shift in the position of his/her own doll made by the user by applying a force on the doll, to the other user's doll; i.e., the position of the dolls can be synchronized.

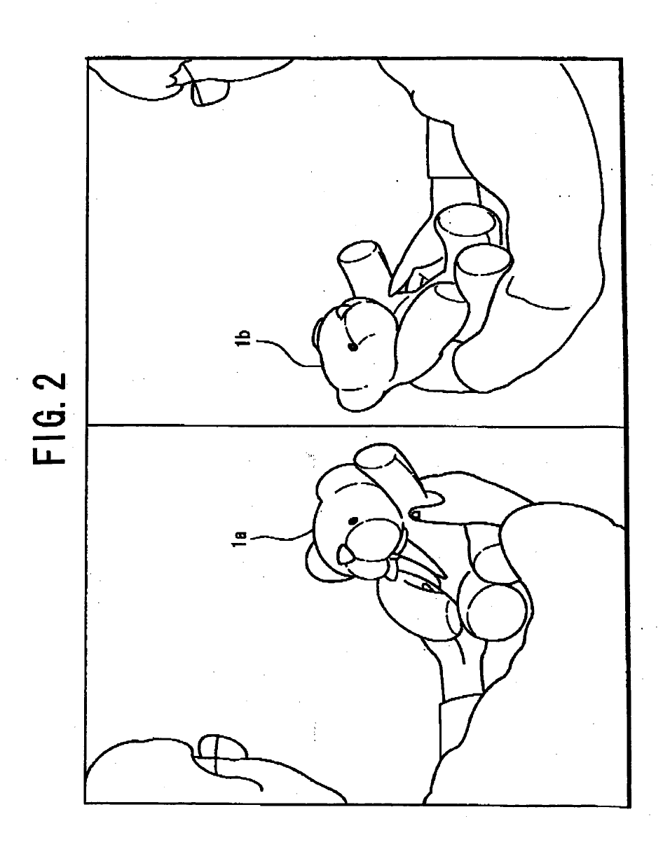

By making the robot-phone in a human- or animal-like shape, as shown in FIG. 1, a robot-phone which enables a communication using gestures can be provided. FIG. 2 shows an example of how the robot-phones 1a, 1b are used to make a speech communication, and of manipulation of the robot-phones 1a, 1b. Two users are making a speech communication and manipulating respective robot-phones 1a, 1b, while facing the respective robot pones 1a, 1b. Most users have an experience of playing dolls and find it not difficult to manipulate an interface of human-like shape. For instance, by waving a hand of one of the robot-phones, the same hand of the other robot-phone can be waved; the gesture indicating “YES/NO” can be realized by a movement of the head. Where both the users simultaneously wave the same hand of the robot-phones, a shake-hands where the users feel the force of each other can be realized. Since a robot-phone is manipulated by two users simultaneously, a robot-phone acts on a user, as a user's double at times and as the other user's double at other times, depending upon the state.

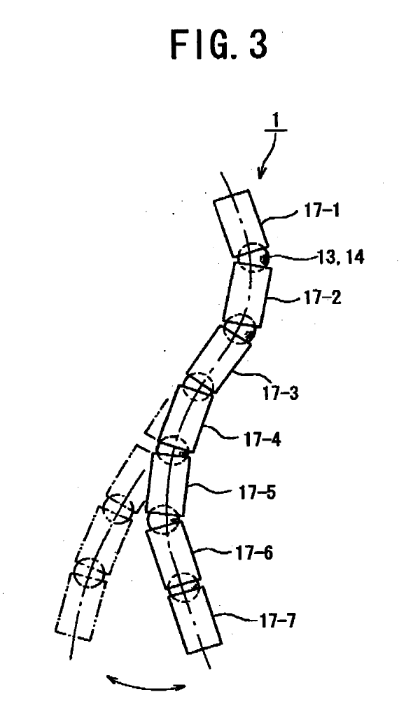

FIG. 3 shows another example of the robot-phone. This robot-phone of snake-like type has a main body comprising a truncal part constituted by seven segments 17-1, 17-2, . . . 17-7. The segments 17-1, 17-2, . . . 17-7 are connected to one another so that the main body as a whole can wriggle like a snake. Each segment has a module constituted by a motor/planetary gear mechanism 13 and a potentiometer 14. In the robot-phone of snake-like type shown in FIG. 3, six servomotors are respectively used as actuators.

The robot-phone of snake-like type is limited in its motion, namely, the robot-phone can move only in a two-dimensional plane. However, a shape can be expressed by the body itself, and the shape can be made as desired by the user by touching the robot-phone with a hand.

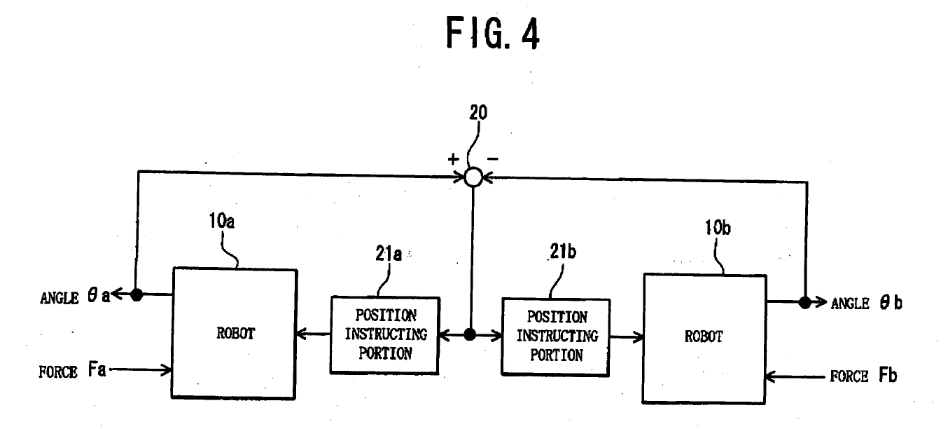

In the above example, a control of the servomotors is performed by software installed on a one-board microcomputer. In driving the motors, the PWM control is employed. As a control method of a bilateral servomechanism, a control method of a symmetrical type as shown in FIG. 4 is employed to keep minimizing a position difference between a pair of servomotors for the same part of the two robots. In FIG. 4, reference numeral 20 denotes a subtractor for obtaining the position difference, while each of reference numerals 21a, 21b denotes a position instructing portion which operates to drive one of a pair of servomotors for the same part of the robots 1a, 1b on the basis of the position difference. An angle signal outputted from each robot 1a, 1b is obtained by the potentiometer 14. A force applied to the robot 1a, 1b acts on a joint of the frame of the robot to shift the position or posture of the robot. In this specification, the term robots refers to a machine conforming to any or all of the shape, construction and function of a living creature.

In the control system shown in FIG. 4, when the user applies a force on the robot 1a or 1b to shift the position thereof, a signal representative of the shift is outputted. The positions of the robots 1a and 1b are compared to each other by the subtractor 20; where the positions are different, i.e., the positions of the robots at a part or all of the joints are not the same, each position instructing portion 21a, 21b issues an instruction to the servomotor of the robot 1a, 1b. Each servomotor operates in response to the instruction, so that the positions of the robots 1a, 1b coincide. For instance, when an arm of the robot 1a is moved upward, the position instructing portion 21b instructs the robot 1b to move the corresponding arm upward. On the other hand, the position instructing portion 21a instructs the robot 1a to move the arm downward, and a manipulator of the robot 1a senses a reaction force. Since the symmetric bilateral control does not require a force sensor, a controller can be simply constructed.

According to the control system of FIG. 4, when the master device is manipulated, the slave device follows suit with the shift in position without delay. Thus, the manipulator of the master device can freely control the shape of the slave device.

In the above example where a manipulation method according to which the shape of the device at hand and the shape of the device as an object of manipulation are synchronized is employed, it is possible to form a shape of the object by performing a real-time interaction with the device at hand. Thus, the user can manipulate the object in a highly intuitive manner. In other words, the device in front of the manipulator serves as a display device which keeps presenting the shape of the remote object. Further, since a completely symmetric bilateral control is realized, there is no distinction between the devices as to which one is the master or slave device, but the devices can manipulate each other. In addition, not only the position, but also the applied force are communicated; for instance, when a joint of one of the devices is restrained from movement by a hand of the manipulator, the other manipulator can sense that the device is so restrained through the device in front of the hands.

The robot-phone is designed such that the users manipulate the robot-phone of each other through a communication line. There maybe a case where the communication line is temporarily disrupted or abruptly disconnected. The system is desirably designed to be held in operation without any trouble even in such a case. This is even more so when considering the fact that the present system is expected to be widely used by general public, unlike the conventional robots for hazardous environments which are used by limited operators.

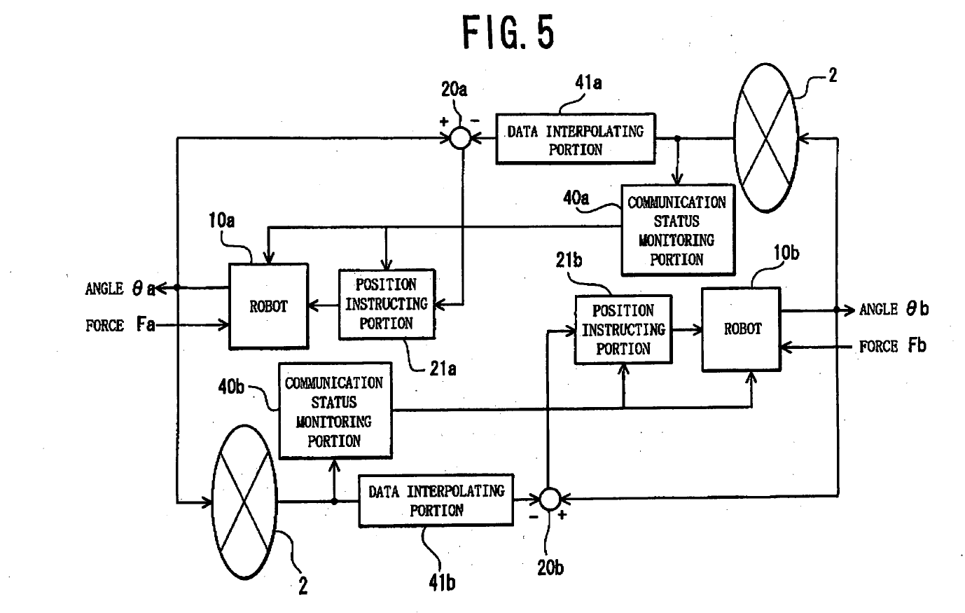

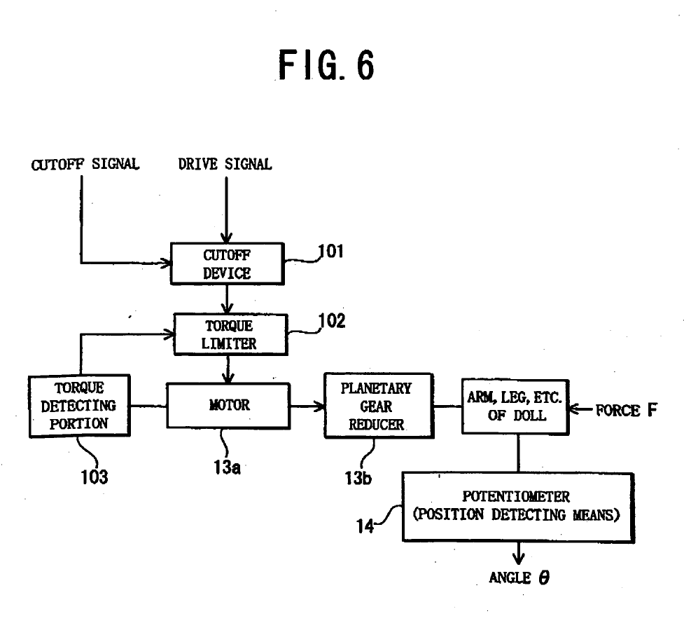

A system to meet such a demand is shown in FIGS. 5 and 6.

In FIG. 5, reference numerals 40a, 40b respectively denote a communication status monitoring portion which monitors the status of the line, namely, whether the line is disconnected and whether there is a partial loss in data received, and outputs a control signal representative of the line condition to the position instructing portion 21a, 21b and/or robot 10a, 10b. When the partial loss of data is found from the received data, a data interpolating portion 41a, 41b interpolates the lost data based on the previous and subsequent communication data. The position instructing portion 21a, 21b drives the servomotor of the main body of the robot 10a, 10b, based on the position difference described above, under control of the communication status monitoring portion 40a, 40b.

FIG. 6 is a block diagram showing the internal structure of the robot 10a, 10b of FIG. 5. In FIG. 6, reference numeral 101 denotes a cutoff device which shuts off the power supply to the motor 13a based on the output from the communication status monitoring portion 40. Namely, when any abnormality is found in the communication, the power supply is shut off. A torque limiter 102 limits the torque produced by the motor 13a, for example, by holding the amount of the electric current supplied to the motor 13a not larger than a constant value. The torque limiter 102 may be a mechanical one. The magnitude of the torque produced by the motor 13a is detected by a torquemeter. 103, and is sent to the torque limiter 102. The torquemeter 103 may indirectly detect the torque, by measuring the value of the electric current supplied to the motor 13a, or directly detect the torque on the shaft of the motor 13a, on the shaft of the planetary gear reducer 13b and/or on a part of the doll such as an arm and leg.

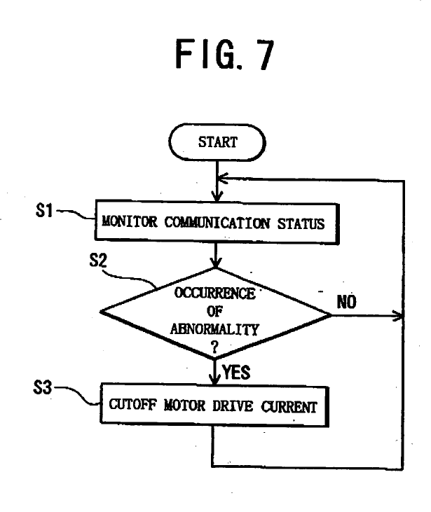

FIG. 7 is a flowchart illustrating an outline of a processing performed in the system. The communication status monitoring portion 40 monitors the communication status (S1). Where an abnormality is found in the communication (an affirmative decision is made in S2), an instruction is issued to the cutoff device 101 to shut off the motor drive current (S3).

As a drive mechanism for the system/apparatus according to the first embodiment, a motor 13a of a relatively large torque and a planetary gear reducer 13b of a relatively small speed reduction ratio are employed. Therefore, while a servo power supply of the robot 10 is cut off, each shaft having a back drivability can be relatively freely moved by application of an external force. While the system is in operation, the robot-phones 1a, 1b mutually keep checking the communication therebetween is performed normally. In the case where any abnormality (e.g., the communication line is disconnected; data has not been received for a predetermined time period: a response (ACK) to a command is not returned even after a predetermined time has lapsed; an abnormally high noise is produced; the signal-to-noise ratio (S/N ratio) is remarkably deteriorated; where a signal is modulated, the carrier wave can not be detected; the frequency of data errors is abnormally high; and the received data is obviously abnormal, i.e., there is received data representative of; an unnatural position of the doll; a movement of an arm or leg in a speed exceeding a possible moving speed: a movement, e.g., waving or swinging of an arm or leg, beyond the limit expectable under the normal conditions) is found in the communication, the cutoff device 101 immediately shuts off the servo power supply of the robot 10. As described above, since the speed reduction ratio of the planetary gear reducer 13b is relatively low, even when the servo power supply of the robot 10 is cut off, each shaft can be freely rotated as desired by application of a force of the user. For instance, where the servo power supply is cut off while a finger of the user is stuck between an arm and body of the robot-phone 1, the user can move the arm to release the finger. It is noted that although in FIG. 6 the cutoff device 101 is provided in the input of the robot 10, the present invention is not so limited. For example, the cutoff device 101 may be provided in the output side, or input side of the position instructing portion 21. Further, instead of the cutoff device 101, there may be provided a switch or biasing means for neutralizing the input signal (i.e., for converting the input signal to indicate a voltage allowing the motor to rotate neither directions, e.g., a ground potential), or a clutch for shutting off the transmission of the driving force of the motor 13a.

Since the torque limiter 102 is provided at the last phase of the control of the controller of each shaft, an excessive torque larger than a predetermined threshold value is never generated in the robot 10, in any situation.

A quality of the communication line 2 may deteriorate. In the event of the deterioration, a data loss of a very short time from a communication data, such as a communication packet loss, which is not considered as a communication abnormality, may be caused. The communication data loss is interpolated by the data interpolating portion 41 based on the previous and subsequent communication data, so as to restore the communication data to some degree. The communication data interpolation by the data interpolating portion 41 is performed by using a method such as holding the previous value, the linear interpolation, the Kalman filter, etc. It is noted that the interpolation is effective where the data loss is of intermittent nature for a relatively short time. However, where the data loss is of a relatively long time, or where a continuous burst error occurs, the interpolation can not restore the data. In such a case, it is desirable that the servo power supply is cut off, as described above. To perform this processing, it is preferable that a signal indicative of that the data interpolating portion 41 is incapable of interpolating the lost data is sent to the communication status monitoring portion 40, which in turn outputs a power cutoff instruction.

According to the system/apparatus of the first embodiment, even where a line fault occurs in a communication line connecting the robot-phones, the user does not suffer from a trouble.

Modification of the First Embodiment of the Invention

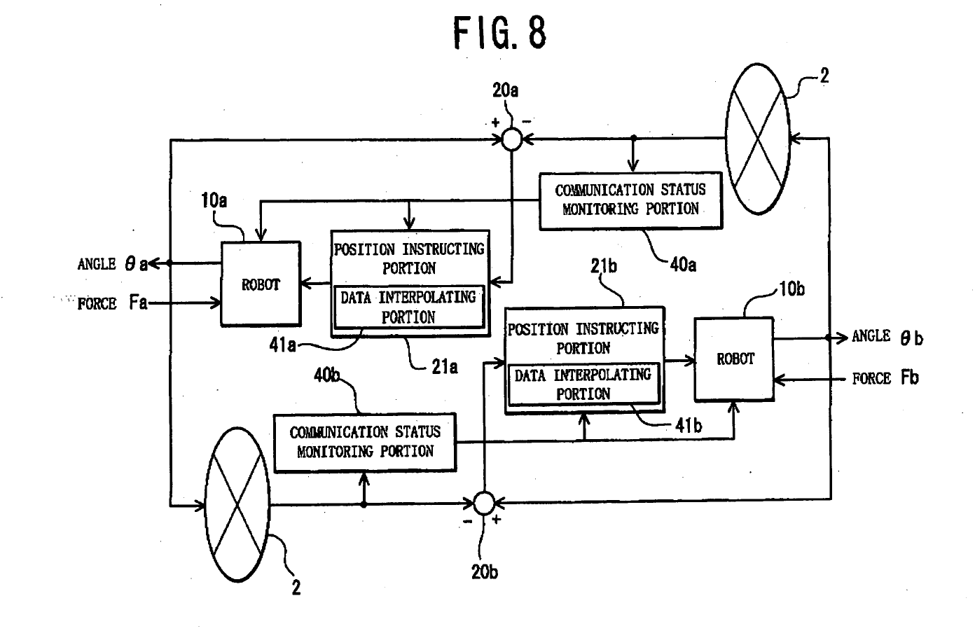

In FIG. 5, the data interpolating portion 41 receives data via the communication network 2, and transmits data, as has been subjected to the interpolation, to the adder-subtractor 20. However, the present invention is not limited to such a construction. For instance, as shown in FIG. 8, the position instructing portion 21 may incorporate the data interpolating portion 41 which performs the interpolation on data as a difference obtained by the subtraction. In the modified arrangement, the same operation and effects as in the first embodiment can be obtained.

Second Embodiment of the Invention

The system/apparatus according to the first embodiment of the invention is for dealing with the line fault in the communication line connecting the robot-phones. In this regard, the communication speed may be temporarily lowered, even if the line condition is not so deteriorated as in the case of a line fault. Further, depending upon the capacity and quality of the communication line on the side of the other user, the communication speed (communication band) may differ significantly. For instance, where a modem is used for the regular telephone line, the communication speed is 28.8 kbps, in the case of the ISDN, 64 kbps. However, in the case of the ADSL a communication of about 8 Mbps is possible, in some cases. (It is noted that the communication speed varies depending upon the distance between the user and the telephone station, and the communication speed may vary from user to user even if the same ADSL is used.) When a communication between users is made through the robot-phones, it is preferable that a control method suitable for a class and condition of the communication line is employed, since the communication band is different depending upon the class and condition of the communication line. In addition, a method capable of notifying the user of the class and condition of the communication line is desirable. A system/apparatus according to a second embodiment of the invention is developed to meet such a demand.

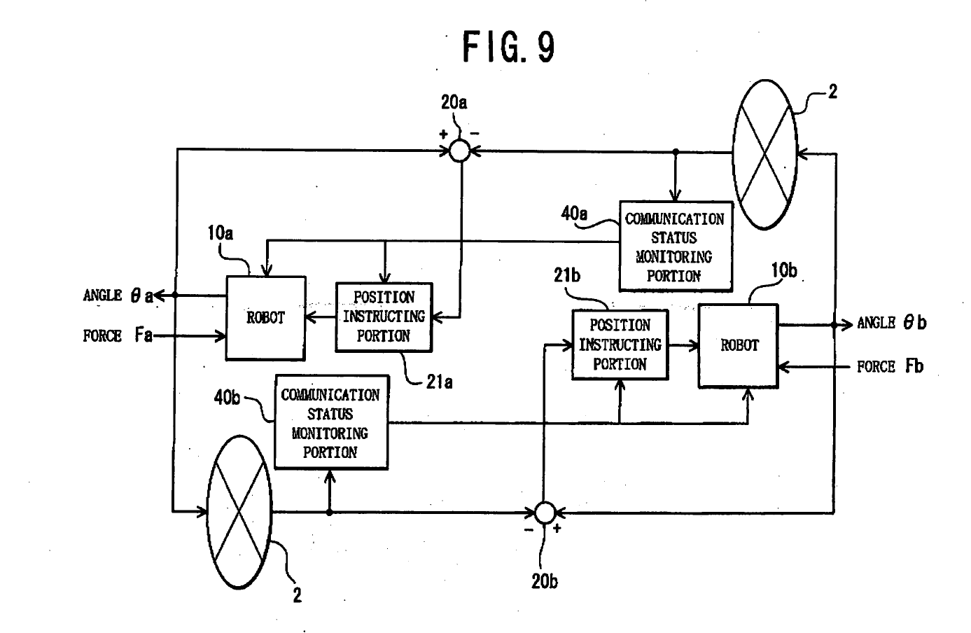

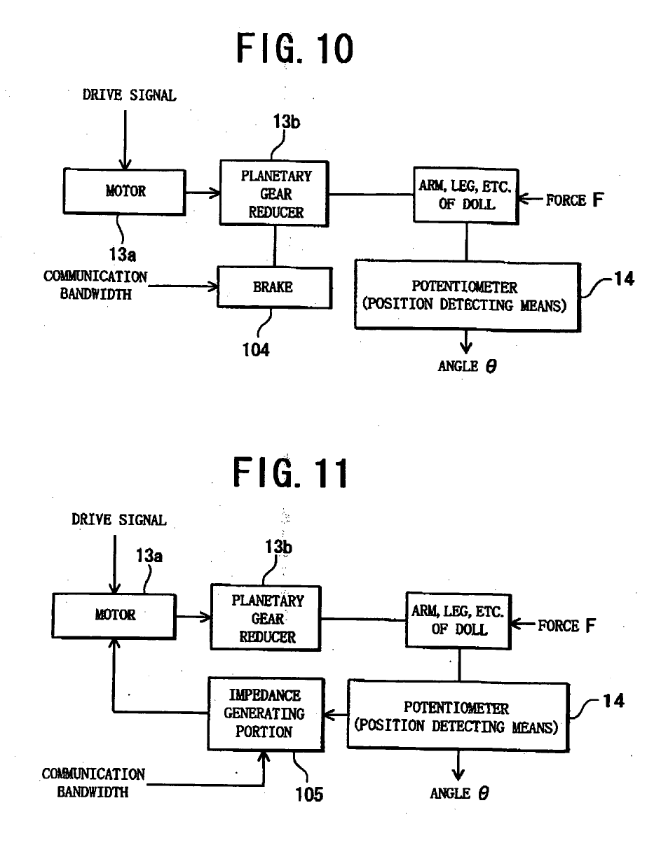

The system according to the second embodiment is shown in FIGS. 9 and 10.

In FIG. 9, a communication status monitoring portion 40a, 40b monitors the condition of the line, i.e., the communication band. For instance, whether the communication line on the side, of the other user is the regular telephone line, ADSL, or CATV is determined on the basis of information obtained when a connection to the other user is established, and the communication band is determined based on the determined kind of the communication line. Alternatively, a communication speed (band) in which a communication is actually performable is determined depending on information such as an error rate and a signal-to-noise ratio (S/N ratio) Further, a protocol may determine the communication speed when the communication is initially established. A control signal corresponding to the communication band (i.e., signal related to the communication bandwidth) is outputted to the position instructing portions 21a, 21b and/or the robots 10a, 10b. The position instructing portions 21a, 21b drive the servomotors of the robot-phones 10a, 10b, respectively, based on the position difference as described above. The operations of the servomotors are controlled by the communication status monitoring portions 40a, 40b.

FIG. 10 is a block diagram showing the internal structure of the robots 10a, 10b of FIG. 9. In FIG. 10, a brake 104 receives a signal from the communication status monitoring portion 40, and applies a braking force to an output shaft of a planetary gear reducer 13b (which is connected to an arm, leg, or others of a doll) and/or a rotating shaft of a motor 13a. When the brake 104 is in operation, the resistance to the movement of the arm, leg or others of the doll by application of an external force increases. The degree of the resistance is adjustable, for instance, in accordance with a signal indicative of the communication bandwidth.

A shift in the communication band changes the input frequency (corresponding to the speed of manipulation) to which the bilateral control system can properly react depending upon the communication bandwidth. Therefore, the frequency (speed of manipulation) allowed to be inputted into the system is limited by using the communication status monitoring portion 40 and the brake 104, depending upon the communication bandwidth. That is, by controlling the robot 10 locally, an impedance of each shaft (easiness in moving the shaft) is dynamically changed. For instance, where the band is wide (i.e., where the communication bandwidth is wide, such as in the case of the ADSL), each shaft is made smoothly movable, while the band is narrow (i.e., where a regular modem is used), the impedance is increased so that a swift movement can not be inputted. A control depending on the class and condition of the communication line is thus enabled. From the user's point of view, the easiness in manipulation (for instance, how much force is required to move the arm, leg or others of the doll) changes depending upon the other user to communicate with and the communication status. That is to say, the user can sense the heaviness of the line through the robot-phone.

Modification of the Second Embodiment

In FIG. 10, the brake 104 is used as means for increasing the impedance at the arm, leg or others of the doll. However, the present invention is not so limited. For instance, as shown in FIG. 11, when an arm, leg or others of the doll is moved by application of an external force, this fact is detected based on a signal from a potentiometer 14, and the motor 13a is driven to produce a torque in the reverse direction. An impedance generating portion 105 determines the magnitude of the torque based on the communication bandwidth. For instance, in the case of ADSL the value of the torque is made zero or small, while in the case of the regular telephone line the value of the torque is made large. In this arrangement, the same operation and effects as the second embodiment can be obtained.

As a method for changing the impedance, a method of controlling a motor, such as one for controlling the impedance of a motor, may be employed, instead of the mechanical mechanism.

For instance, there may be employed an electric brake provided by short-circuiting a terminal of the motor 13b (that is, the impedance can be varied depending upon the resistance value between the terminals of the motor 13b), or, adding an impedance generating motor which generates a torque in the reverse direction.

More commonly, an impedance control well-known in the field of the teleexistence technology is applicable. The impedance control is a control related to the dynamical interaction between robot and environment, where dynamic characteristics of the movable parts and environment are described by a mechanical impedance model. The control method considers a dynamical interaction between a robot and an environment as a change in impedance, and considers the robot and environment as an integral object to control. In the second embodiment, to change the impedance corresponds to changing a parameter of the impedance for each robot or entire robot-phone system.

Third Embodiment of the Invention

There is a problem that an oscillation tends to occur in a control system when a usual bilateral control is performed through a line suffering from a communication delay. This is because that feedback is returned from the other user always with a delay, due to the communication delay. In such a case, it is difficult to construct a control system which does not easily oscillate.

Conventionally, the symmetrical bilateral control, simple as it is, was not often used, due to its characteristic that a weight of a device or a part thereof as a remote object to control is returned to the manipulator without being processed. Thus, a more advanced feedback control method is more often used, and a proposition to solve the problem of communication delay in the simple symmetrical bilateral control has not been made.

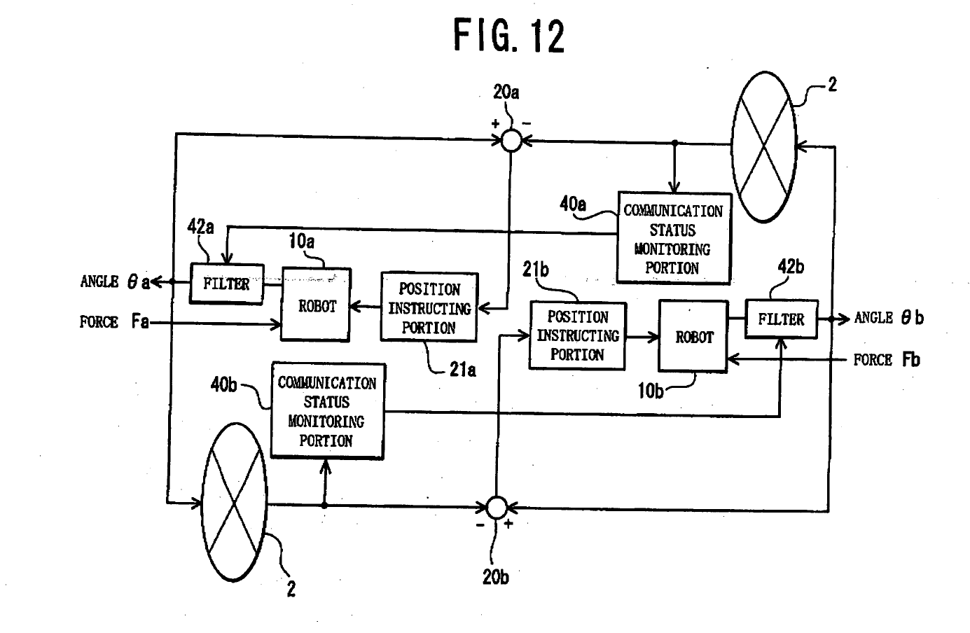

To solve the problem of communication delay, the method of limiting the input frequency depending upon the shift in the communication band, as described with respect to the second embodiment, can be used. A method for preventing the oscillation due to the delay will be described by reference to FIG. 12.

In FIG. 12, communication status monitoring portions 40a, 40b monitor the status of the line, i.e., the communication band, and output respective control signals corresponding to the communication band (i.e., signals related to the communication bandwidth) to filters 42a, 42b, respectively. Each filter 42a, 42b extracts a signal within a predetermined band from an angle signal outputted from the robot 10, and outputs the extracted signal. The band of the signal to be extracted (a parameter of the filter such as a time constant) is controlled based on the output from the communication status monitoring portion 40. The position instructing portion 21a, 21b drives a servomotor of the main body of the robot 10a, 10b based on the position difference as described above.

In the third embodiment of the invention, after a manipulator on one side initiates manipulating the robot 10, the result of the manipulation is outputted as an angle signal which is fed back to the robot 10 of the manipulator on the other side. The band of the signal fed back is limited correspondingly to the communication band of the communication network 2, thereby suppressing the oscillation of the control system.

For instance, where a communication is made between two robot-phones each of which is designed or adjusted to perform optimally when the communication band is coincident with a predetermined width, when the communication bandwidth is wider than the predetermined width, the filter 42 outputs the input signal without processing the signal. On the other hand, where the communication band is narrower than the predetermined width, the filter 42 extracts a signal within the band usable by the robot-phone on the other user's side and feeds back the signal to the other user. This is because that in the case where the communication band is narrower than the predetermined width, if the input signal is outputted without being processed, the other user's robot-phone can not completely follow the signal, leading to an unnatural movement of the robot-phone, which in turn invites a repeat or abort of a manipulation.

A filter function having no relation to the control based on the communication band may be provided to the filter 42. For instance, a function to eliminate a signal of a higher frequency than the proper response speed of the system is provided. In this case, it can be configured such that when the user moves the arm, leg or others of the doll of the robot 10 in a speed too high for the motor 13a of the other user's robot to drive the relevant doll part, such a manipulation is not fed back. Alternatively, a function to eliminate a dc component (an absolute value of an angle) of an angle signal generated in a robot 10 may be provided. In this case, only an angle (i.e., angular difference) in which an arm, leg or others of the doll of the user is moved is transmitted to the other user's doll, and the positions of the two robot-phones (positions of an arm, leg or others) are differentiated but in this state (in the differentiated positions) the arm, leg or others can be waved or swung in the back-and-force and lateral directions in synchronization. Further alternatively, a function to eliminate a predetermined low frequency component may be provided. In this case, the drift in the output of the potentiometer 14 can be eliminated, as well as an overload of the motor 13a due to its continuous operation can be avoided where the positions of the two robot-phones are not coincident (e.g., when the two users are moving the same arm into different states).

Modification of the Third Embodiment of the Invention

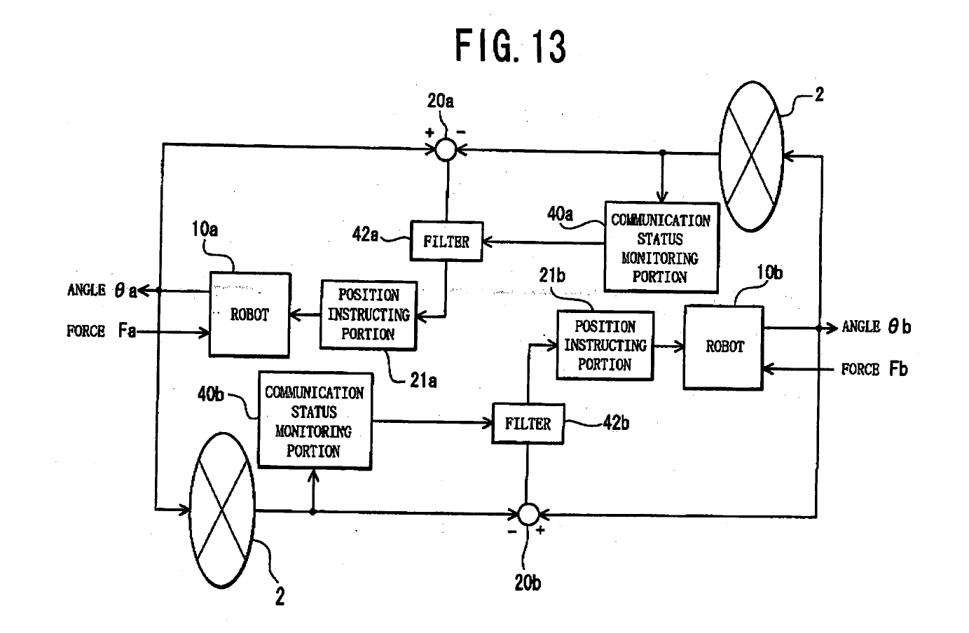

In FIG. 12, the filter 42 is provided on the output side of the robot 10. However, the filter 42 may be provided on the input side of the position instructing portion 21. Such an example is shown in FIG. 13. In this example, the band of a signal fed back from the other side of the communication is limited.

For instance, where a communication is made between two robot-phones each designed or adjusted to perform optimally when the communication band is coincident with a predetermined width, when the communication band is wider than the predetermined width, the filter 42 outputs the input signal without processing the signal. On the other hand, where the communication band Is narrower than the predetermined width, the filter 42 extracts a signal within the bandwidth usable by the robot-phone.

In addition, a filter function having no relation to the control based on the communication band may be provided to the filter 42, similarly to the <third embodiment.

It is to be understood that the present invention is not limited to the above-described embodiments, but various modifications may be made without departing from the scope of the invention as defined in the appended claims, and such modifications are included in the invention.

In the present specification, the terms “portion” and “means” do not necessarily refer to physical means, but each function referred to by these terms may be implemented by software. Further, a function of a single portion/means may be implemented by two or more physical means, or, functions of two or more portions/means may be implemented by a single physical means.

1. A robot-phone characterized by comprising: a robot which is used as a user interface, and comprises a movable portion at a part of a body of the robot-phone, a driving portion which drives the movable portion, a position information sensor which outputs a signal indicative of a position of the movable portion, and a shut-off portion which stops an operation of the driving portion; and a communication connecting portion,
wherein the communication connecting portion transmits the signal indicative of the position of the movable portion outputted from the position information sensor, to a partner of a communication via a communication line, and receives position information of the movable portion from the partner and sends the position information to the driving portion,
wherein the driving portion drives the movable portion based on the position information,
and wherein the communication connecting portion monitors the status of the communication line, and stops an operation of the driving portion by operating the shut-off portion where an abnormality of the communication line is found.

2. The robot-phone according to claim 1, characterized in that the communication connecting portion determines that the communication line is abnormal, where any of the following conditions is established: the communication line is disconnected; data has not been received for a predetermined time period; a response to a command is not returned even after a predetermined time has lapsed; an abnormally high noise is generated; a signal-to-noise ratio is remarkably deteriorated; where a signal is modulated, a carrier wave can not be detected; a frequency of data errors is abnormally high; and an obviously abnormal data is detected.

3. The robot-phone according to claim 1, characterized by comprising a limiter which holds a drive force produced by the driving portion not larger than a threshold.

4. The robot-phone according to claim 1, characterized in that the communication connecting portion monitors the status of the communication line, and when a data loss is found in communication data, an interpolation is performed on the basis of previous and/or subsequent communication data.

5. A robot-phone characterized by comprising: a robot which is used as a user interface, and comprises a movable portion at a part of a body of the robot-phone, a driving portion which drives the movable portion, apposition information sensor which outputs a signal indicative of a position of the movable portion, and an impedance varying means which varies an impedance of the movable portion; and a communication connecting portion,
wherein the communication connecting portion transmits the signal indicative of the position of the movable portion outputted from the position information sensor, to a partner of a communication via a communication line, and receives position information corresponding to the movable portion from the partner and sends the position information to the driving portion,
wherein the driving portion drives the movable portion based on the position information,
and wherein the communication connecting portion monitors the status of the communication line, and sends a signal indicative of the status to the impedance varying means to thereby vary the impedance of the movable portion accordingly.

6. The robot-phone according to claim 5, characterized in that the communication connecting portion operates to control the movable portion such that where a band of the communication line is wide, the movable portion is made smoothly movable, and where the band of the communication is narrow, the impedance of the movable portion is increased to prevent a swift movement from being input.

7. The robot-phone according to claim 6, characterized in that the communication connecting portion determines a class of the communication line on the side of the communication partner based on information obtained when a connection therewith is initially established, the band of the communication line is determined depending upon the determined class, and the impedance of the movable portion is changed depending upon the determined band of the communication line.

8. The robot-phone according to claim 6, characterized in that the communication connecting portion monitors an error rate and/or a signal-to-noise ratio in a communication to determine a band in which the communication is performable, and the impedance of the movable ratio is changed depending upon the determined band.

9. The robot-phone according to claim 5, characterized in that the impedance varying means varies the impedance of the movable portion by means of a mechanical mechanism provided to the movable portion.

10. The robot-phone according to claim 5, characterized in that the impedance varying means varies the impedance of the movable portion by performing a predetermined control of the driving portion.

11. A robot-phone characterized by comprising: a robot which is used as a user interface, and comprises a movable portion at a part of a body of the robot-phone, a driving portion which drives the movable portion, and a position information sensor which outputs a signal indicative of a position of the movable portion; and a communication connecting portion comprising a filter which limits a frequency of an input signal into the robot and/or of an output signal from the robot,
wherein the communication connecting portion transmits the signal indicative of the position of the movable portion outputted from the position information sensor, to a partner of a communication via a communication line, and receives position information of the movable portion from the partner and sends the position information to the driving portion,
wherein the driving portion drives the movable portion based on the position information,
and wherein the communication connecting portion monitors the status of the communication line, and adjusts characteristics of the filter depending upon the status.

12. The robot-phone according to claim 11, characterized in that the communication connecting portion operates such that where a band of the communication line is wider than a predetermined band, the input signal into the filter is outputted without being processed, and where the band of the communication line is narrower than the predetermined band, the filter operates as a low-pass filter and/or a band-pass filter.

13. The robot-phone according to claim 11, characterized in that the filter eliminates a signal of a higher frequency than a proper response speed of a system, so that a manipulation of the movable portion in a speed higher than an allowable maximum speed for the driving portion is not fed back.

14. The robot-phone according to claim 11, characterized in that the filter eliminates a dc component of the position information, so that positions of two robots on opposite sides of the communication line can be differentiated.

15. The robot-phone according to claim 11, characterized in that the filter eliminates a predetermined low frequency component.
